(19) United States
(12) Patent Application Publication
(10) Pub. No.: US 2026/0111486 A1
(43) Pub. Date: Apr. 23, 2026

(54) CONFLICT MANAGEMENT FOR CONSISTENT CONTENT UPDATING USING A GENERATIVE NEURAL NETWORK

(71) Applicant: Google LLC, Mountain View, CA (US)

(72) Inventors: Florian Nils Hartmann, Zurich (CH); Matthew Sharifi, Kilchberg (CH)

(21) Appl. No.: 18/921,579

(22) Filed: Oct. 21, 2024

(51) Int. Cl. G06F 16/901

(52) U.S. Cl. CPC G06F 16/9024

(57) ABSTRACT

Methods, systems, and apparatus, including computer programs encoded on a computer storage medium, for consistent execution of multiple requests specifying modifications to a content item. In one aspect, a system comprises a method for obtaining a first content item, receiving a plurality of requests from one or more users, each request specifying a respective modification to the content item to be made by a first generative neural network, processing the plurality of requests to generate data representing a request graph, wherein each edge connects a respective pair of nodes that represent a non-conflicting pair of requests, determining a set of non-conflicting requests using the data representing the request graph, and modifying the first content item to generate a modified content item, comprising executing the set of non-conflicting requests using the generative neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that provides for consistent execution of multiple requests received from one or more users that each specify a respective modification of a content item, e.g., a textual, visual, code, or audio output.

In particular, the system can receive multiple requests in parallel, e.g., from a group of users submitting requests concurrently, or can receive multiple requests as part of receiving a large request that can be broken down into several requests.

When receiving requests from multiple users regarding modifications to the same content item, it is likely that one or more of the requests will conflict. In this specification, a pair of conflicting requests refers to a pair of requests that require the setting of a property of the content item to multiple different values that are inconsistent with one another, e.g., requests that specify modifications to the textual, visual, code, or audio output that cannot both be executed.

More specifically, the system can receive the requests from one or more users and generate a request graph representing the relationships between the requests, e.g., by determining edges that connect nodes representing non-conflicting requests. The system can then use the request graph to determine a set of non-conflicting requests, e.g., the largest set of non-conflicting requests, and can execute the non-conflicting requests to generate a modified content item. As another example, the system can be configured to evaluate an importance weight for each request, e.g., in order to identify the set of non-conflicting requests in accordance with one or more user-defined criteria based on the importance weight.

In some cases, the system can also iteratively update the modified content item using the remaining set of requests that are not in the set of non-conflicting requests, e.g., leftover requests. In particular, the system can provide for the streamlined execution of any leftovers requests by identifying an unrestricted portion of the modified content item that was not updated as part of executing the set of non-conflicting requests, executing a leftover request, and updating the unrestricted portion based on the executed leftover request, e.g., by further restricting the portion of the modified content item that can be modified by additional leftover requests.

Particular embodiments of the subject matter described in this specification can be implemented so as to realize one or more of the following advantages.

Handling multiple requests with respect to modifying a content item presents issues when the requests require the setting of one or more properties of the content item to inconsistent values. It can be difficult to discern how to execute the requests due to the conflicts, and the more requests the system receives, the higher the likelihood that the system receives a larger number of conflicting requests.

To account for this, the system of this specification can allow for the consistent execution of requests without conflict. In particular, the system can receive requests from one or more users, can identify any conflicts between the requests, and can execute the set of non-conflicting requests. In some cases, the system can also identify an unrestricted portion of the content item and can iteratively execute one or more of the leftover requests that are not in the set of non-conflicting requests and pertain to the unrestricted portion. More specifically, the system can streamline the execution of requests by generating a request graph that represents the requests that can be efficiently implemented without conflict. The system can leverage the request graph to reduce the number of inference calls to the generative neural network, e.g., since the relationships represented by the request graph specify a consistent execution strategy for the requests.

The system can generate the request graph by aggregating information pertaining to the relationships between requests, e.g., whether or not a pair of requests is conflicting and whether or not a pair of requests is mergeable as a single request. In particular, the system can use the request graph to systematically determine which requests can be executed jointly in a single execution call to the generative neural network. For example, the set of non-conflicting requests can be executed in a single execution call. As another example, the system can merge, e.g., combine, one or more pairs of requests that do not conflict and pertain to the same anchorpoint, e.g., the same corresponding portion of the content item. In the case that one or more requests have been merged or deemed part of the set of non-conflicting requests, the system can execute an aggregated request in a single inference call to the generative neural network. In general, by reducing the number of inference calls to the generative neural network, the system can reduce the use of computational resources required to execute the requests, e.g., since computing an inference call with a generative neural network involves a computation with millions or billions of neural network parameters, thereby requiring the allocation of a large amount of computational memory and processing power.

In addition, the system can execute the set of non-conflicting requests in parallel using the generative neural network. In particular, executing the set of non-conflicting requests can further reduce the use of computational resources necessary to execute the requests, e.g., since the set of non-conflicting requests can be executed in parallel as opposed to consecutively using the generative neural network. By executing the requests in parallel, the system can reduce the computational resources required to execute the set of non-conflicting requests, e.g., since the system can efficiently leverage multiple processing units, thereby better utilizing available hardware and reducing execution time.

Moreover, the system can reduce the computational resources necessary to generate the request graph using anchorpoints, e.g., the respective corresponding portion of the content item that each request pertains to. More specifically, the system can use anchorpoints to determine which pairs of requests need to be evaluated for conflict, e.g., based on whether each request specifies a change to the same or a similar portion of the content item. By leveraging the anchorpoints, the system can bypass the need to process every possible pair of received requests using the generative neural network, or in some cases, a management model configured to generate the request graph, thereby further reducing the number of total inference calls to a neural network while still effectively editing the content item. In particular, processing every possible pair of requests scales quadratically with the number of requests, e.g., requiring a large allocation of computational resources, especially in the case that the system receives a large volume of requests.

Furthermore, the system can be implemented for online content modification. In particular, the system can continually update the request graph for a content item with incoming requests as they are received. In this case, the system can evaluate whether the incoming request can be executed, e.g., based on previously executed requests, using the request graph, and can execute the request in real-time, if there is no conflict. Furthermore, in some cases, the system can be configured to warn a user that their request will cause a conflict with the already executed requests, e.g., by way of an applied-programming interface, as a user is entering a request, thereby providing direct feedback to a user regarding their request. For example, the user can consider this direct feedback to revise their request before submitting it.

In an example implementation, the system can improve the maintainability of a codebase by managing conflicting requests to modify the codebase, e.g., the system can allow for code consistency and reliability by ensuring that executing requests does not result in a compilation error.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example content item modification system.

FIG. 2 illustrates how the system of FIG. 1 can prompt an example generative neural network to evaluate the compatibility of incoming requests.

FIG. 3 illustrates how the system of FIG. 1 can prompt an example generative neural network to determine an anchorpoint for a request.

FIG. 4 demonstrates how the system of FIG. 1 can prompt the example generative neural network to iteratively further restrict portions of the modified content item when executing leftover requests that were not in the set of non-conflicting requests.

FIG. 5 is a flow diagram of an example process for modifying a content item using a set of non-conflicting requests.

FIG. 6 is a flow diagram of an example process for further modifying the modified content item resulting from the process of FIG. 5 using requests that were not in the set of non-conflicting requests.

Like reference numbers and designations in the various drawings indicate like elements.

### DETAILED DESCRIPTION

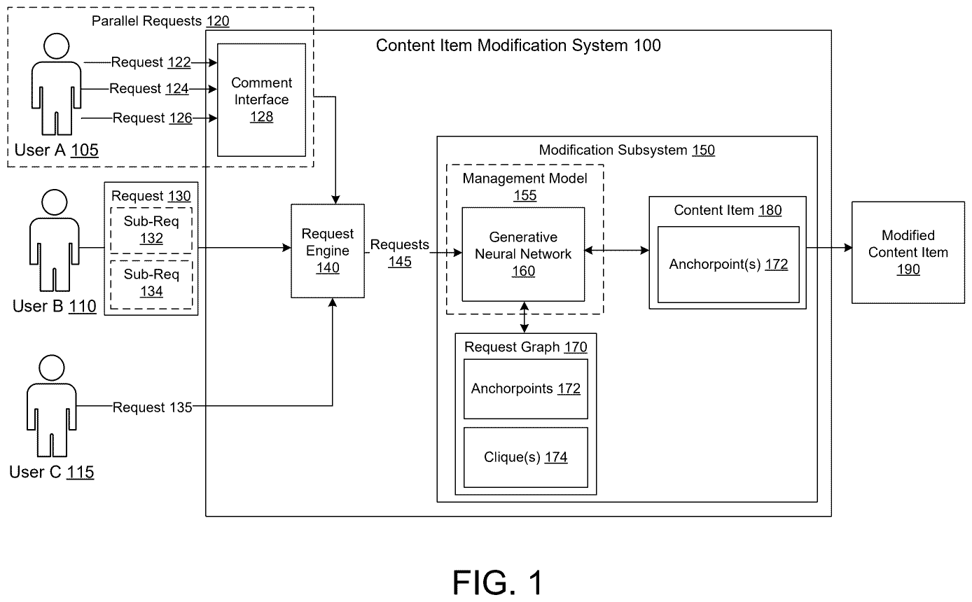

FIG. 1 shows an example content item modification system 100. The content item modification system 100 is an example of a system implemented as computer programs on one or more computers in one or more locations in which the systems, components, and techniques described below are implemented.

The content item modification system 100 can be used to iteratively refine a generated output, e.g., a content item 180. For example, the content item modification system 100 can be used for editing an image, e.g., to restore a distorted image, editing a video, or modifying a shared codebase. As another example, the content item modification system 100 can be used for writing and revising an essay, generating and tailoring a presentation, picture, or song, or merging offline changes to a document from one or more users.

More specifically, the content item modification system 100 can be used to organize the non-conflicting execution of multiple requests that each specify a respective modification of the content item 180, e.g., a textual, visual, code, or audio output. As an example, the system can receive requests A, B, C, D, and E, and can execute requests A, B, and C, after determining that request D conflicts with request A and request E conflicts with request C.

In particular, the system 100 can generate a modified content item 190 by identifying a set of non-conflicting requests for execution, e.g., the requests A, B, and C, executing the set of non-conflicting requests using a generative neural network 160, and, in some cases, iteratively executing one or more leftover requests using the generative neural network 160, e.g., requests that were not executed as part of the set of non-conflicting requests for execution, e.g., the requests D and E, by restricting the editable portion of the modified content item 190.

The system 100 can obtain the content item 180 from any appropriate source. For example, the system 100 can obtain the content item 180 from a user, e.g., the user A 105, user B 110, or user C 115, e.g., and the user can have created the content item by initializing a file, taking a picture or recording a video, etc. As another example, the system 100 can obtain the content item 180 from a first generative neural network, e.g., the generative neural network 160, or a second generative neural network, e.g., a different generative neural network (not pictured) of the system 100 or another system.

In the case that the system 100 obtains the content item 180 from a generative neural network, the system 100 can obtain the content item 180 from a generative neural network configured to generate the content item 180. For example, in the case that the content item is a textual output, the system 100 can obtain the content item 180 from a recurrent neural network, encoder-decoder neural network, or transformer-based neural network. As another example, in the case that the content item is a visual output, the system 100 can obtain the content item 180 from a generative-adversarial neural network, a diffusion neural network, e.g., a stable diffusion model, or a transformer-based model, e.g., a vision transformer. As yet another example, in the case that the content item is an audio output, the system 100 can obtain the content item 180 from a recurrent neural network, an encoder-decoder neural network, or a language processing neural network.

The system 100 can receive multiple requests from the one or more users, e.g., user A 105, user B 110, and user C 115. In particular, the system 100 can receive multiple requests from the users A 105, B 110, and C 115. The system 100 can then process the requests in batches using a request engine 140, which will be described in more detail below.

While only three users are depicted in FIG. 1, the system 100 can receive a request from any arbitrary number of users, e.g., 10, 50, 200, or 1000 users. As an example, a request can be formatted as a query, e.g., a directive instruction, that the system 100 can process using a generative neural network 160 to modify the content item 180.

For example, one or more users, e.g., the user C 115, can input the request 135 directly to the system. In particular, the request 135 can include text specifying the modification to the content item 180. For example, the request 135 can specify a revision to an essay, a theme suggestion for a presentation, or additional entities, e.g., a person, a brand, or an object, to incorporate in an image. As another example, the request 135 can specify a mood change for an audio clip, a formatting change to a document, or an overriding style change, e.g., from impressionism to dadaism, for an image.

As another example, one or more users, e.g., the user A 105, can input multiple requests as parallel requests 120 using a comment interface 128. In this case, the comment interface 128 can allow a user to identify a portion of the content item 180 for modifying, e.g., by providing the content item 180 for display, e.g., on a user device of the user A 105, and an option to select a portion of the content item 180 and specify a modification to the portion of the content item 180, and can allow for the controlled submission of entered requests, e.g., using a submit button. For example, the user can use the comment interface 128 to input the requests 122, 124, and 126 and can submit the requests to be executed in parallel using the comment interface 128.

As yet another example, one or more users, e.g., the user B 110, can enter a single request 130, which can be decomposed into several requests, e.g., the sub-request 132 and the sub-request 134. In particular, the system 100 can designate that the request 130 be broken up into several component sub-requests in the case that the request 130 exceeds a length criterion, includes multiple conditions, topics, or goals, or specifies a complex reasoning task that can be broken down into component sub-tasks.

In some cases, the sub-requests 132, 134 can be easily identified from the request 130, e.g., the request 130 can include a delineated list of requests. In other cases, the sub-requests 132, 134 can be identified from the request 130, e.g., by processing the request 130 using a rule-based engine, a dependency parser, or an intent detection model. For example, the request engine 140 can include the rules-based engine, dependency parser, or intent detection model.

In the case that the request engine 140 includes an intent detection model, the intent detection model can be a neural network model with any appropriate machine learning architecture that can be configured to process a request to detect different intended tasks as sub-requests. In particular, the intent detection model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In particular, the system 100 can receive the requests, e.g., the request 135, the parallel requests 120, and the sub-requests 132 and 134 using the request engine 140. In particular, the request engine can be configured to receive, batch, and transmit the requests 145 to a modification subsystem 150. In this context, batching refers to receiving an input stream of requests and buffering the input stream into respective sets of requests, e.g., by caching incoming requests over a predefined time interval, e.g., within milliseconds, seconds, or hours, by caching incoming requests with respect to a maximum batch size, or using dynamic batching, and transmitting the requests received during the interval to the modification subsystem 150.

The request engine 140 can be implemented as a data processing apparatus, logic circuitry, or another type of hardware module. The system 100 can program the hardware components to receive and manage the submission of requests to the modification subsystem 150 and to interface with other system components, e.g., for storage. In the case that the system 100 is configured for online modification to update the content item 180 within real-time computing constraints, the request engine 140 can be implemented with customized accelerator circuitry such as FPGAs (Field-Programmable Gate Arrays) or ASICs (Application-Specific Integrated Circuitry),

The system 100 can process the requests 145, e.g., a batch of requests, using the modification subsystem 150 to identify and execute the set of non-conflicting requests and, optionally, any leftover requests, e.g., requests not in the set of non-conflicting requests, to modify the content item 180.

In particular, the modification subsystem 150 can process the requests 145 to generate data representing a request graph 170 that represents the relationships between the requests 145, e.g., which requests are conflicting or non-conflicting, and can use the request graph 170 to organize the consistent execution of the requests 145.

In some cases, the system 100 can leverage parallel processing to process multiple batches, e.g., of requests 145. In this case, by batching the requests for parallel processing, the system 100 can process large volumes of requests, e.g., from a large number of users, e.g., 50, 100, 1000, without introducing significant delays.

More specifically, the system can generate the request graph 170 using a generative neural network 160 or a management model 155, e.g., in the case that the generative neural network is not configured to identify any conflicts between requests. As an example, the requests 145 can specify that a part of an image, e.g., a person's clothing, be different colors or that a person's face both be brightened and clarified or darkened and softened when restoring an image. As another example, the system can receive a first request to modify a module in a codebase and a second request to modify a function within the module in the codebase.

As yet another example, the requests 145 can specify that the mood of the sound effects for a video be both more refined and more sitcom-esque. As a further example, the requests 145 can specify desired modifications to a document that are not compatible, e.g., by requesting that a body paragraphs be revised to present a related concept of the subject of the essay, e.g., reasons for visiting Zurich, in both a more positive and more negative light.

In particular, the request graph 170 can include a set of nodes representing respective requests, and a set of edges representing respective connections between pairs of non-conflicting requests. In this context, non-conflicting requests include requests that can be implemented without conflict, e.g., without requiring the setting of a property of the content item to multiple inconsistent values.

For example, the generative neural network 160 can be a generative-adversarial network, a diffusion model, a variational autoencoder, or a normalizing flow. In this case, the generative neural network 160 is configured to generate and modify a content item, e.g., the content item 180, but is not configured to identify any conflicts between requests. In this case, the modification subsystem 150 can include a management model 155 to generate the request graph 170.

The management model 155 can have any appropriate machine learning architecture, e.g., a neural network, that can be configured to process an input pair of requests and determine the relationship between the requests, e.g., whether the requests conflict. In particular, the management model 155 can have any appropriate number of neural network layers (e.g., 1 layer, 5layers, or 10 layers) of any appropriate type (e.g., fully-connected layers, attention layers, convolutional layers, etc.) connected in any appropriate configuration (e.g., as a linear sequence of layers, or as a directed graph of layers).

For example, the management model 155 can be implemented as an autoregressive language processing network. In particular, the management model 155 can have a recurrent neural network architecture that is configured to sequentially process the contents of the requests and trained to perform next element prediction, e.g., to define a likelihood score distribution over a set of next elements. More specifically, the management model 155 can include one or more of a recurrent neural network (RNN), long short-term memory (LSTM), or gated-recurrent unit (GRU). As another example, the management model 155 can be a transformer-based model e.g., an encoder-decoder transformer, an encoder-only transformer, or a decoder-only transformer, as will be described in more detail below.

As another example, the generative neural network 160 can be a language processing neural network, e.g., a large language model or a vision language model. In this case, the generative neural network 160 can be configured to both generate and modify a content item, e.g., the content item 180, and to identify any conflicts between requests. In this case, the system 100 does not need to include a management model 155 in the modification subsystem 150, e.g., since the generative neural network 160 can be used to generate the request graph 170. However, in some cases, the system 100 can include both a generative neural network 160 implemented as a language processing neural network and management model 155, e.g., to directly adapt each model 155, 160 for the respective tasks of identifying any conflicts between requests and modifying the content item 180.

For example, the generative neural network 160 can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

As another example, the generative neural network 160 can be a vision language model (VLM) that can be configured to process an image, or sequence of images in a video, and text to generate an image. For example, the generative neural network 160 can be a unified image-to-image translation (UNIT) model, a diffusion model, an attention generative adversarial network (AttnGAN). In some cases, the generative neural network 160 can be a vision transformer (ViT) guided by a contrastive language-image pre-training (CLIP) model, e.g., to ensure the image generated aligns with a user's text prompt. In particular, the generative neural network 160 can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

In the case that the generative neural network 160 is a language processing neural network or a vision language model, or the case that the management model 150 is a language processing neural network, the system 100 can prompt the generative neural network 160, or the management model 150, to generate the request graph 170. In this case, the system 100 prompting the model refers to the system generating and providing a prompt, e.g., a directive instruction or question, to the generative neural network 160, or the management model 150.

While described below with respect to processing prompts using the generative neural network 160, the system 100 can process the prompts using the management model 150, the generative neural network 160, or both.

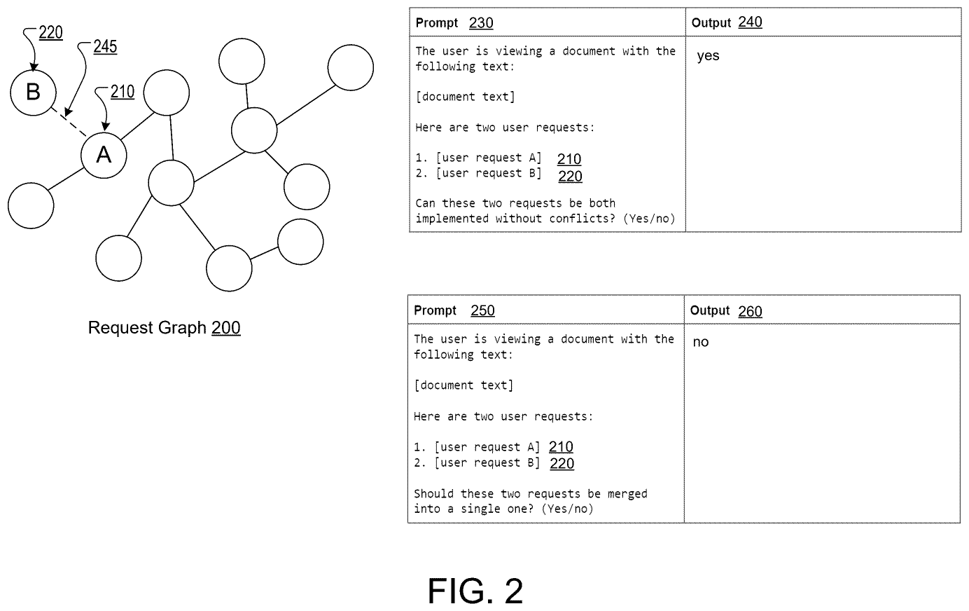

For example, the system 100 can generate a sequence of prompts for each pair of requests in the requests 145 including an instruction to evaluate whether each pair of requests can be implemented without conflict. An example prompt for assessing whether a pair of requests is non-conflicting is described in more detail with respect to FIG. 2. In particular, the modification subsystem 150 can use the generative neural network 160 to process each pair of requests 145 with the respective corresponding prompt to determine whether to generate an edge between the pair of requests. More specifically, in response to the generative neural network 160 determining that a pair of requests is non-conflicting, the modification subsystem 150 can generate an edge between the pair of requests in the request graph 170.

In the case that the generative neural network evaluates a pair of requests specifying modifications to a codebase, e.g., a first request specifying a modification to a module and a second request specifying a modification to a function within the module, the generative neural network can determine whether a compilation conflict exists, e.g., using a compiler or an interpreter. In particular, the system can ensure that executing the requests does not result in a compilation error.

Furthermore, in some cases, in response to the generative neural network 160 determining that a pair of requests is non-conflicting, the modification subsystem 150 can additionally determine whether the pair of requests is mergeable. In this case, a pair of requests is mergeable if the non-conflicting requests specify a modification to the same portion of the content item 180. In the case that the generative neural network 160 determines that the pair of requests is mergeable, the modification subsystem 150 can aggregate the pair of requests as a single node in the request graph 170. An example prompt for assessing whether a pair of requests is mergeable is described in more detail with respect to FIG. 2.

In particular, each of the requests 145 can correspond to an anchorpoint, e.g., each request can specify a modification to a respective portion of the content item 180. As an example, an anchorpoint can be one or more text lines or a range of characters of a document, a region of an image, or a particular interval of a sound clip. Each node of the request graph 170 can include the corresponding anchorpoint for the request, e.g., the request graph 170 can represent the relationships between requests and the anchorpoints 172 corresponding with each request.

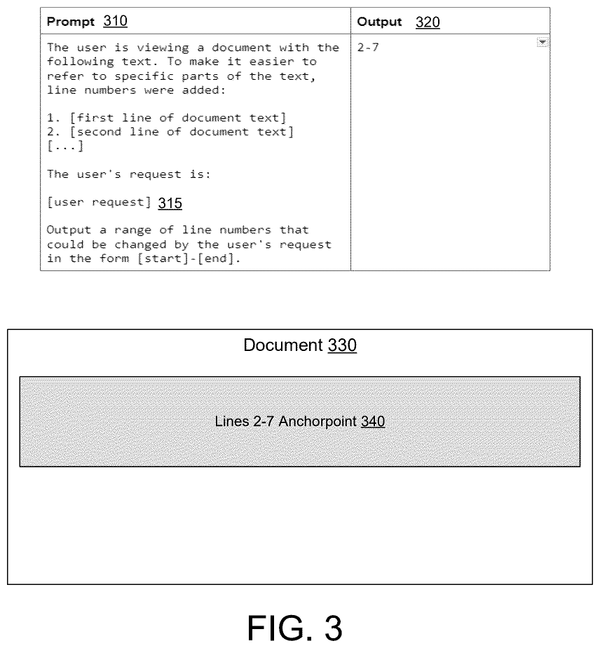

In some cases, the system 100 can receive the corresponding anchorpoints 172 for the requests 145, e.g., as part of each input request. In other cases, the system 100 can determine the anchorpoints 172 for the requests 145. In this case, the system 100 can process the request and the content item 180 using the generative neural network 160 to with an instruction to identify the corresponding anchorpoint for the request, e.g., as is described in greater detail with respect to FIG. 3.

In some cases, the modification subsystem 150 can aggregate one or more anchorpoints, e.g., adjacent line numbers, adjacent segmentation masks, or adjacent audio tokens. For example, the subsystem 150 can identify and aggregate anchorpoints using a similarity criterion, e.g., based on a similarity score for one or more anchorpoints exceeding a similarity threshold value. As another example, the subsystem 150 can aggregate anchorpoints using a significance criterion specifying that a threshold number of requests refer to each anchorpoint considered by the modification subsystem 150, etc. In this case, the subsystem 150 can select anchorpoints that can be combined to ensure that each of the remaining anchorpoints is associated with the threshold number of requests.

In some cases, e.g., in the case that the number of requests 145 exceeds a threshold number of requests, the modification subsystem 150 can use the anchorpoints 172 to designate which of the possible pairs of requests can be evaluated using the generative neural network 160, or the management model 155, and which can be entered into the graph as non-conflicting, e.g., without processing the pair of requests using the model 155 or 160. In particular, in the case that it is computationally expensive to consider every pair of the requests 145, e.g., since the number of pairs scales quadratically with the number of requests 145, the subsystem 150 can apply heuristics using the anchorpoints 172 to limit the total number of pairs to be processed using the generative neural network 160 or the management model 155. More specifically, bypassing the processing of the quadratic number of pairs of requests 145, allows the subsystem 150 to more efficiently generate the request graph 170.

For example, if a pair of requests have anchorpoints for different regions of the content item 180, then it is unlikely that the pair of requests conflict. In particular, the system 100 can evaluate the similarity of the anchorpoints as compared to a threshold distance, e.g., by embedding the anchorpoints in an anchorpoint embedding space that represents the content item 180 and determining a distance between the anchorpoint embeddings, in order to determine whether the anchorpoints are close enough to be evaluated using the generative neural network 160 or the management model 155. By leveraging the anchorpoints to determine whether or not to evaluate a pair of requests, the system can circumvent the need to process every possible pair of received requests, thereby reducing the number of total inference calls to the generative neural network while still effectively editing the content item.

Furthermore, in the case that the system 100 determines that the anchorpoints can be aggregated, e.g., merged into the same anchorpoint, the system can evaluate whether the requests pertaining to the aggregated anchorpoint are mergeable. As an example, the system 100 can aggregate the anchorpoints and merge requests to further reduce the number of inference calls to the generative neural network 160 when executing requests, e.g., since multiple mergeable requests can be combined into a single request.

The modification subsystem 150 can use the generated request graph 170 to identify a set of non-conflicting requests for execution. In particular the subsystem 150 can identify one or more clique(s) 174, e.g., one or more subsets of vertices within the graph that form a complete subgraph such that each pair of vertices in the subset is connected by at least one edge, using the request graph 170.

As an example, the subsystem 150 can identify the largest clique of non-conflicting requests, e.g., using the determined edges representing non-conflicting pairs of requests. In particular, the subsystem 150 can identify the largest subset of nodes in the request graph 170 that are mutually connected by one or more edges to every other node in the subgraph as the set of non-conflicting requests for execution.

As another example, the subsystem 150 can identify different possible non-conflicting cliques 174 and select a clique of non-conflicting requests with a highest importance score for execution. In this case, each request can be associated with an importance weight, e.g., based on the user that submitted the request to the system 100. For example, the system 100 can determine an importance weight based on a user identifier of the user submitting the request, e.g., user C 115 can be the manager of user A 105 and user B 110, and the system 100 can be configured to assign a larger importance weight to user C 115 due to their position. As another example, the system 100 can determine an importance weight based on the order at which the requests were received.

In particular, in the case that each request is assigned an importance weight, the subsystem 150 can identify one or more cliques 174 of non-conflicting requests and generate an importance score for each clique by aggregating, e.g., summing, the importance weights for each node in the clique. In this case, the subsystem 150 can determine the set of non-conflicting requests for execution based on the clique of non-conflicting requests with the highest importance score.

The modification subsystem 150 can then execute the set of non-conflicting requests, e.g., by processing each request of the set of non-conflicting requests with the content item 180 using the generative neural network 160 to modify the content item 180. In particular, the subsystem 150 can execute the set of non-conflicting requests in parallel, e.g., since each of the requests can be implemented without conflict in the content item 180.

By executing the set of non-conflicting requests in parallel, the subsystem 100 can reduce the computational resources necessary to execute the requests without conflict. For example, the subsystem 150 can distribute the execution of the set of non-conflicting requests across one or more computing devices. For example, the subsystem 150 can make better use of the available hardware on a single device, e.g., by leveraging multi-core processing, to execute the requests in parallel. As another example, the subsystem 150 can implement multiple instances of the generative neural network 160 in parallel, e.g., across respective computing devices, and can transmit jobs including non-overlapping subsets of requests to each of the models for execution. Furthermore, executing the requests in parallel is more efficient and can enhance the user experience with the system 100, e.g., since the set of non-conflicting requests can be executed more quickly.

In some cases, the system can provide the modified content item 190, e.g., to one or more of the users 105, 110, or 115. As an example, the system can provide the modified content item 190 for display on a display of a user device corresponding with one or more of the users 105, 110, or 115.

In other cases, the subsystem 150 can iteratively update the modified content item 190 using the leftover requests, e.g., the requests that were not in the set of non-conflicting requests. In particular, the subsystem 150 can identify an unrestricted portion of the modified content item 190, e.g., the portion that was not updated as part of executing the non-conflicting requests, and any leftover requests that were not in the set of non-conflicting requests and pertain to the unrestricted portion. More specifically, the subsystem 150 can identify and restrict the portion of the modified content item 190 that was modified using the set of non-conflicting requests, e.g., by comparing the obtained content item 180 with the modified content item 190, to identify the unrestricted portion for further editing using the leftover requests.

In some cases, the subsystem 150 can additionally determine whether any of the restricted portion is still eligible for further modification, e.g., based on the possibility of higher-level requests specifying stylistic changes that can impact the restricted portion without necessarily conflicting. As an example, in the case that the generative neural network is capable of contextual reasoning, e.g., that the generative neural network is a language processing neural network or a vision language model, the generative neural network can determine whether any of the restricted portion is still eligible for further editing as part of the unrestricted portion. In this case, the generative neural network can select one or more sub-portions of the modified content item 190 that was edited using the set of non-conflicting requests as sub-portions of the unrestricted portion that can be edited further.

The subsystem 150 can identify any leftover requests that pertain to the unrestricted portion, e.g., using the corresponding anchorpoints for the requests, and can iteratively execute one or more of the leftover requests. In particular, the subsystem 150 can select a leftover request and attempt to execute the request in the unrestricted portion. For example, the subsystem 150 can select a leftover request for attempted execution by randomly sampling a leftover request from the leftover requests, or can select a leftover request based on a hierarchy determined by a heuristic, e.g., the subsystem can implement a heuristic based on the user that made the request, based on the overlap between the leftover request and the unrestricted portion, or any other appropriate heuristic to determine an order of attempted execution for the leftover requests.

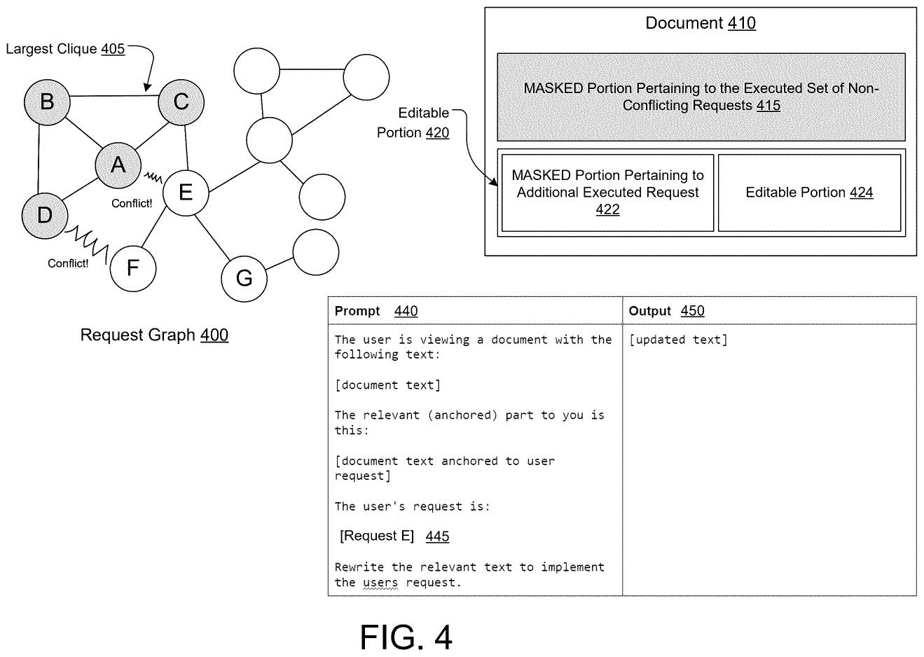

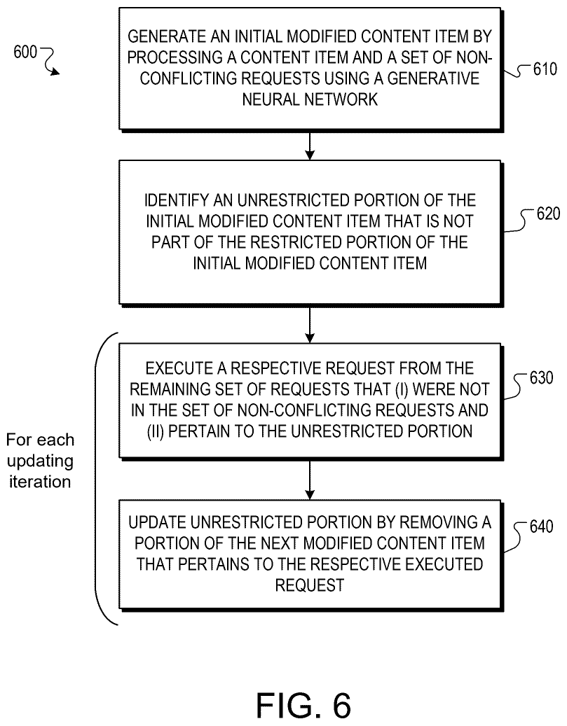

In the case that the subsystem 150 executes a selected leftover request, the subsystem 150 can update the unrestricted portion based on the executed request, e.g., to further restrict the portion of the modified content item 190 that can be updated using the remaining leftover requests. An example for iteratively updating the modified content item 190 will be described in more detail with respect to FIG. 4 and FIG. 6.

FIG. 2 illustrates how the system of FIG. 1 can prompt an example generative neural network to evaluate the compatibility of incoming requests. In this context, the compatibility of incoming requests refers to whether a given pair of requests is non-conflicting, mergeable, or both.

In the particular example depicted, the system is considering whether to generate an edge between request A 210 and request B 220 as part of generating the request graph 200. Both request A 210 and request B 220 refer to modifications to be made to a document. As an example, request A 210 can refer to revising the tone of the third paragraph and request B 220 can refer to revising the formatting of the tables included in the document.

For example, the system can generate the prompt 230 to instruct the generative neural network to evaluate whether or not the pair of requests, e.g., request A 210 and B 220, can be implemented without conflict in the document. The system can process the prompt 230 using the generative neural network to determine whether or not request A 210 and request B 220 can be implemented without needing to set one parameter of the content item to two different values.

In this case, the generative neural network can generate the output 240, which specifies that request A 210 and B 220 can be implemented without conflict. In some cases, since the generative neural network determined that request A and request B can be implemented without conflict, the system can then generate an edge 245 between request A 210 and request B 220 in the request graph 245.

In other cases, the system can further evaluate whether or not the requests are mergeable before adding the edge 245. In particular, in response to determining that the request A 210 and B 220 can be implemented without conflict, the system can generate the prompt 250 to instruct the generative neural network to evaluate whether or not the pair of requests, e.g., request A 210 and B 220, can be merged in the request graph 200, e.g., as a single node. The system can then process the prompt 250 using the generative neural network to generate the output 260.

In this case, since request A 210 refers to the third paragraph, request B 220 refers to the formatting of tables in the document, and there are no tables in the third paragraph, the output 260 specifies that the requests are not mergeable. In the case that the requests were mergeable, the system can generate a new merged request that includes both the request A 210 and request B 220 in a single node.

In some cases, the system can be adapted for online content modification. In this case, the system can use a prompt similar to prompt 230 to evaluate an incoming request and each of the executed requests that are in the request graph 200. As an example, in the case that the system can process the prompt 230 using the generative neural network within real-time computing constraints, the system can additionally warn the user submitting the request, that the request will cause a conflict, e.g., by way of an applied-programming interface. In this case, the user entering the request can consider this warning and, e.g., revise their request before submitting.

FIG. 3 illustrates how the system of FIG. 1 can prompt an example generative neural network to determine an anchorpoint for a request.

In the particular example depicted, the content item is the document 330, e.g., a textual item. In this case, the system 100 can identify one or more corresponding text lines as the anchorpoint by processing the document and a request using the generative neural network with an instruction to identify the corresponding one or more text lines or a range of characters as the anchorpoint for the request.

In particular, the system can generate the prompt 310, which includes the user request 315, to instruct the generative neural network to determine the specific portion of the document that the user's request 315 refers to. The system can then process the prompt 310 using the generative neural network to generate the output 320 which defines the anchorpoint 340 of lines 2-7 in the document.

While depicted here with respect to a textual content item, the system can use a prompt similar to prompt 310 to instruct the generative neural network to determine, e.g., the segmentation masks for a request specifying a modification to a visual output or the indices of audio tokens for a request specifying a modification to an audio output. In particular, the audio tokens can correspond with one or more audio samples from the audio output.

As a related example, the document 330 can be a shared codebase and the system can identify one or more corresponding lines of code as the anchorpoint by processing a portion of the codebase, e.g., a module or file, to identify the one or more lines of code as the anchorpoint.

As another example, in the case that the content item is a visual item, e.g., an image or a video, the system can extract segmentation masks from the visual item, e.g., by processing the visual item using a segmentation model, e.g., a Segment Anything Model (SAM) or a Segformer, to identify segmentation masks, e.g., representing people, buildings, foods, etc. The system can then process the segmentation masks and the request using the generative neural network with an instruction to identify the corresponding segmentation masks as the anchorpoint for the request.

As yet another example, in the case that the content item is an audio item, e.g., an audio effect clip or a narrated presentation, the system can identify the interval of the audio item corresponding with the request. In particular, the audio item can have been generated by decoding one or more audio tokens, and the system can identify an index for each of the one or more audio tokens corresponding with the request by processing the audio tokens and the request using the generative neural network with an instruction to identify the corresponding audio tokens as the anchorpoint for the request.

FIG. 4 demonstrates how the system of FIG. 1 can iteratively execute leftover requests after executing the set of non-conflicting requests. In some cases, after executing the set of non-conflicting requests, the system can prompt the example generative neural network to iteratively mask, e.g., restrict, portions of the modified content item from further editing to ensure that executing a request that was not in the set of non-conflicting requests does not lead to a conflict where a conflict had been previously identified.

In the particular example depicted, the system has identified the largest clique 405 of the request graph 400, e.g., requests A, B, C, and D, as the set of non-conflicting requests. In this case, the requests in the request graph 400 pertain to the document 410. After executing the set of non-conflicting requests, the system can restrict the portion of the document that pertains to the set of non-conflicting requests from further editing, e.g., the portion 415, resulting in the editable portion 420.

In particular, the system can compare the original document to the modified document 410 in order to identify the portion 415 of the document that should be restricted from further editing. For example, the system can process the original document and the modified document 410 using the generative neural network with an instruction to identify the differences and restrict the portion 415 that was modified using the set of non-conflicting requests.

In some cases, the generative neural network can additionally determine whether any of the portion 415 is still eligible for further editing. In the particular example depicted, the generative neural network can select one or more sub-portions of the text that were edited as sub-portions that are part of the editable portion 420 and can be edited further.

As an example, one or the executed requests in the set of non-conflicting requests can have been a high-level request that is eligible for refinement, e.g., the request can have specified the addition of a paragraph about a new topic, e.g., about Samoyeds, but the paragraph that was added can still be eligible for stylistic modifications specified in the leftover requests, e.g., a direction to use active voice throughout the document 410. In this case, the system can designate the added paragraph about Samoyeds as part of the editable portion 420, but restrict the paragraph from changes that conflict with the topic of the paragraph.

After identifying the portion 415, the system can mask the portion 415 from further editing by the generative neural network. In the context of modifying a document 410, masking the portion pertaining to the executed set of non-conflicting requests 415 refers to marking a section of the text as un-editable using delimiters, e.g., by inserting [[MASKED]] both before and after the portion that the generative neural network can ignore. As another example, the generative neural network can be configured to output an identification of the lines that were modified, e.g., after each execution of a request in the set of non-conflicting requests. In this case, the system can instruct the generative neural network to not edit the portion between the identified lines, can constrain the decoding of the generative neural network to only allow modifications to other lines, or can resample outputs from the generative neural network until an output that does not modify the identified lines is achieved.

As yet another example, the system can mask tokens in an audio item to prevent the generative neural network from modifying them or can embed a portion of an image into a different embedding space to prevent further modification using the generative neural network. The system can iteratively execute any leftover requests to continue to modify the initial modified content item. In particular, the system can select the request E 445 from the leftover requests and can generate and process the prompt 440 using the generative neural network with the instruction to edit the editable portion 420 with request E 445. More specifically, since request E 445 conflicts with request A in the request graph 400, the system can instruct the generative neural network to execute request E 445 in the editable portion 420.

In some cases, the generative neural network is able to execute the entire request E 445 within the editable portion 420. For example, the generative neural network can execute request E 445 and output the updated text as the response 450 that edits the editable portion 420, and further restrict the editable portion of the document to the editable portion 424, e.g., by masking the portion pertaining to the additional executed request 422. More specifically, the system can increasingly restrict the editable portion 424 with every executed request that was not in the set of non-conflicting requests in order to ensure that executing a leftover request does not interfere with the already modified portion of the content item.

Additionally, in some cases, after executing a leftover request the system can verify that the restricted portion, e.g., the portion pertaining to the executed set of non-conflicting requests 415, was not updated, e.g., using a post-processing filter. As an example, in the case that the generative neural network incorrectly modified the restricted portion 415 when executing the request E 445, the system can replace the incorrectly modified portion with the masked text from the previous iteration.

In other cases, the generative neural network is unable to execute the entire request E 445 within the editable portion 420. In this case, the generative neural network can either not execute the request E 445 or can only execute a portion of the request E 445, e.g., the portion that can be executed within the editable portion 420, and can record the unexecuted portion of the request E 445. For example, the system can generate a new leftover request that includes the portion of the request E 445 that conflicts with request A, e.g., the unexecuted portion of request E 445.

The system can iteratively execute the leftover requests, e.g., the requests not in the set of non-conflicting requests, with the generative neural network and the increasingly restricted content item, e.g., document 410, e.g., until a threshold criterion is met. In some cases, the threshold criterion can be a number of executed leftover requests, e.g., 5, 10, 50. In other cases, the threshold criterion can be based on the unrestricted portion of the document 410, e.g., if the editable portion is less than a threshold amount of the content item, e.g., the document 410.

For example, in response to determining that the threshold criterion is met, the system can return the modified content item to one or more users, e.g., the users that submitted the requests to modify the document 410. In particular, the system can provide the modified document and the remaining set of requests that were not in the set of non-conflicting requests and were not executed in any of the updating iterations, e.g., any unexecuted leftover requests or the portion of a request that was unexecutable based on the restricted portion, to the users. As an example, the users can use the remaining set of requests to continue to revise the document.

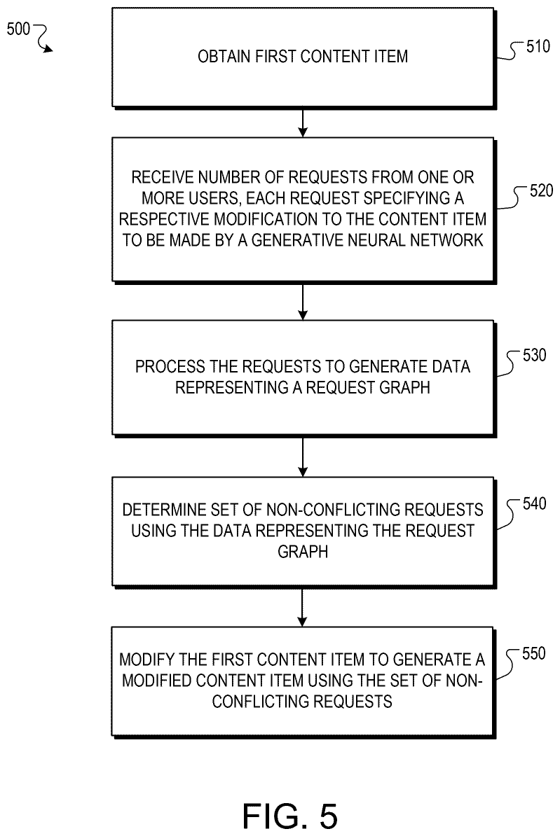

FIG. 5 is a flow diagram of an example process for modifying a content item using a set of non-conflicting requests. For convenience, the process 500 will be described as being performed by a system of one or more computers located in one or more locations. For example, a content item modification system, e.g., the content item modification system 100 of FIG. 1, appropriately programmed in accordance with this specification, can perform the process 500.

The system can obtain a first content item (step 510), and the system can receive a number of requests from one or more users (step 520). In particular, each request can specify a respective modification to the first content item. For example, the first content item can be a textual item, e.g., a shared document, code that can be executed to render a website, a text message, etc. As another example, the first content item can be a visual item, e.g., an image, a video, an advertisement, etc. As yet another example, the first content item can be an audio item, e.g., a sound clip, a song, a person narrating a slideshow, etc.

For example, the system can receive an input stream of requests and buffer the input stream into batches, e.g., batches that include a respective set of requests. As an example, the number of requests can be the set of requests in a particular batch. In particular, each request can specify a respective modification to the first content item to be made by a generative neural network, e.g., generative-adversarial neural network, a recurrent neural network, an encoder-decoder neural network, stable diffusion neural network, or a transformer-based neural network, e.g., a language processing model or vision language model, to the first content item.

In some cases, the system can generate the first content item using the generative neural network. In other cases, the system can obtain the first content item as output from a different generative neural network. For example, the system can receive the first content item as output from a generative-adversarial neural network, recurrent neural network, encoder-decoder neural network, or stable diffusion neural network, and can modify the first content item according to the received requests using a language processing model or vision language model.

For example, the system can determine the respective portion of the first content item to which each request corresponds. In some cases, each request can include an anchorpoint that explicitly specifies the corresponding portion of the first content item for the respective request. In some cases, the system can obtain the anchorpoint for each request, e.g., by receiving the anchorpoint with the request, or by determining the anchorpoint for each request. For example, the anchorpoints can be segmentation masks that the system has extracted from a visual item. As another example, the anchorpoints can be one or more text lines or a range of characters in a textual item. As yet another example, the anchorpoints can be one or more audio tokens in an audio item.

In the case that the system determines the anchorpoint for each request, the system can determine the anchorpoint for the request by processing the request and the first content item using the generative neural network with an instruction to identify the corresponding anchorpoint for the request. In the case that the first content item is a visual item, the system can identify the segmentation mask corresponding with each request by extracting a number of segmentation masks from the visual item, e.g., using a segmentation neural network, and processing the segmentation masks and the first content item with the instruction to identify the corresponding segmentation mask for the request. In the case that the first content item is a textual item, the system can process the textual item and the request to identify the corresponding one or more text lines for the request. In the case that the first content item is an audio item, the system can process the audio item and the request to identify the corresponding one or more audio tokens for the request, e.g., using an index of the audio tokens.

Furthermore, the system can aggregate one or more anchorpoints based on a similarity criterion for the one or more anchorpoints, e.g., a generated similarity score exceeding a similarity threshold value for the anchorpoints, a significane criterion that a threshold number of requests refer to each anchorpoint, etc. In particular, in the case that the anchorpoints refer to a portion of the first content item that can be deemed to be the same portion, e.g., adjacent line numbers, adjacent segmentation masks, or adjacent audio tokens, the system can aggregate the one or more anchorpoints into a single aggregated anchorpoint, e.g., such that the requests that referred to each of the one or more anchorpoints in the single aggregated anchorpoint refer to the single aggregated anchorpoint.

In other cases, or additionally, the request can include an importance weight, e.g., that the system determines based on an identifier of the one or more users that submitted each of the requests, e.g., a user id of each user submitting the request, an order at which requests were received, etc.

The system can process the requests to generate data representing a request graph (step 530). In particular, the system can generate a set of node objects representing each received request corresponding to a portion of the first content item and a set of edge objects representing a non-conflicting pair of requests. For example, the system can process each pair of requests in the number of requests to determine whether the pair of requests is non-conflicting. More specifically, the system can process a model input that includes a given pair of requests using a generative neural network, e.g., the generative neural network or another generative neural network, with an instruction to determine whether the pair of requests can be implemented without conflict, e.g., without requiring the setting of a property of the first content item to multiple inconsistent values. In response to determining that a given pair of requests is non-conflicting, the system can generate an edge between the pair of requests in the request graph.

As another example, in response to determining that the pair of requests is non-conflicting, the system can determine whether the pair of requests is mergeable by processing a second model input that includes the pair of requests using a generative neural network, e.g., the generative neural network or another generative neural network, with an instruction to determine whether the pair of requests relate to a same portion of the first content item. For example, each node embedding can represent a respective request corresponding to an anchorpoint. In response to determining that the pair of requests is mergeable, e.g., based on a shared anchorpoint, the system can aggregate the pair of requests as a single node in the request graph, e.g., to represent the combination of the two requests into one request.

The system can determine a set of non-conflicting requests using the data representing the request graph (step 540). For example, the system can identify a clique of nodes, e.g., a complete subgraph of nodes, that includes the largest set of non-conflicting requests using the edges connecting one or more pairs of nodes in the request graph. In this case, a clique refers to a subset of nodes in the request graph where each node in the subgraph is connected by one or more edges to every other node in the subgraph. As another example, in the case that each request is assigned an importance weight, the system can identify one or more cliques of non-conflicting requests and generate an importance score by aggregating importances weights for each clique of non-conflicting requests. The system can then determine the set of non-conflicting requests as the clique of non-conflicting requests with a highest importances score.

The system can then modify the first content item to generate a modified first content item using the set of non-conflicting requests (step 550). More specifically, the system can modify the first content item by executing the set of non-conflicting requests using the generative neural network. In particular, the system can generate the modified content item by processing the first content item and the set of non-conflicting requests using the generative neural network with an instruction to implement the set of non-conflicting requests. Furthermore, in some cases, the system can also iteratively update the modified content item by identifying an unrestricted portion of the modified content item that was not updated as part of executing the non-conflicting requests and modifying the unrestricted portion, e.g., as is described in more detail with respect to FIG. 6. In some cases, the system can provide the modified content item for presentation to the one or more users, e.g., for further editing based on the unexecuted requests, by providing the modified content item for display on respective user-devices of the one or more users.

FIG. 6 is a flow diagram of an example process for further modifying a modified content item using requests that were not in the set of non-conflicting requests. For convenience, the process 600 will be described as being performed by a system of one or more computers located in one or more locations. For example, a content item modification system, e.g., the content item modification system 100 of FIG. 1, appropriately programmed in accordance with this specification, can perform the process 600.

The system can generate an initial modified content item by processing a first content item and a set of non-conflicting requests using a generative neural network. For example, the system can generate the initial modified content item using the process 500 of FIG. 5.

The system can then identify an unrestricted portion of the initial modified content item (step 520). In particular, the system can identify the unrestricted portion of the initial modified content item by restricting the portion of the initial modified content item that was modified by executing the set of non-conflicting requests as un-editable. As an example, restricting the portion of the initial modified content item can involve masking the initial modified content item, e.g., by freezing the one or more modified text lines, segmentation masks, or audio tokens pertaining to the executed set of non-conflicting requests.

The system can execute a respective request from the remaining set of requests that (i) were not in the set of non-conflicting requests and (ii) pertain to the unrestricted portion (step 530), and the system can update the unrestricted portion by removing a portion of the next modified content item that pertains to the respective executed request (step 540). For example, the system can identify a request that can be executed in the unrestricted portion, e.g., by selecting a request from the remaining set of requests, and can generate a next modified content item by processing the modified content item and the respective request using the first generative neural network with an instruction to execute the respective request. The system can then identify a new unrestricted portion by further restricting the portion of the next modified content item that pertains to the executed request.

In particular, the system can repeat steps 530-540 at each of a number of updating iterations. More specifically, at each updating iteration, the system can select a request from the remaining set of requests for attempted execution. For example, the system can select a request from the remaining set of requests by randomly sampling the request from the remaining set of requests. As another example, the system can select a request from the remaining set of requests based on a hierarchy determined by a heuristic, e.g., the subsystem can implement a heuristic based on the user that made the request, based on the overlap between the request and the unrestricted portion of the content item, or any other appropriate heuristic to determine an order of attempted execution for the leftover requests. In the case that the system is able to execute the request, the system can generate a next modified content item and identify a new unrestricted portion for further editing.

In some cases, in response to determining that the unrestricted portion is less than a threshold amount of the next modified content item, the system can provide the next modified content item to one or more users, e.g., for further editing, based on the remaining set of requests. In this case, the system can provide the remaining set of requests that (i) were not in the set of non-conflicting requests and (ii) were not executed in any of the updating iterations to at least one of the one or more users to at least one of the one or more users. For example, a receiving user can decide to not implement the remaining set of requests or can evaluate how best to implement the remaining set of requests based on any conflicts.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining a first content item;
receiving a plurality of requests from one or more users, each request specifying a respective modification to the content item to be made by a first generative neural network;
processing the plurality of requests to generate data representing a request graph, wherein the request graph comprises:
   a set of nodes, each node representing a respective request corresponding to a respective portion of the first content item; and
   a set of edges, each edge connecting a respective pair of nodes that represent a non-conflicting pair of requests;
determining a set of non-conflicting requests using the data representing the request graph; and
modifying the first content item to generate a modified content item, comprising executing the set of non-conflicting requests using the generative neural network.

Embodiment 2 is the method of embodiment 1, further comprising:
providing the modified content item for presentation to the one or more users.

Embodiment 3 is the method of any one of embodiments 1-2, further comprising:
generating the first content item using the first generative neural network; or obtaining the first content item as output from a second generative neural network.

Embodiment 4 is the method of any one of embodiments 1-3, wherein receiving the plurality of requests from one or more users comprises:
receiving an input stream of requests; and
buffering the input stream into batches, each comprising a respective set of requests, and wherein the plurality of requests are the respective set of requests in a first batch.

Embodiment 5 is the method of any one of embodiments 1-4, wherein processing the plurality of requests to generate data representing the request graph comprises, for each pair of requests in the plurality of requests:
determining whether the pair of requests is non-conflicting by processing a model input comprising the pair of requests using a third generative neural network with an instruction to determine whether the pair of requests can be implemented without conflict.

Embodiment 6 is the method of embodiment 5, further comprising:
in response to determining the pair of requests is non-conflicting, generating an edge between the pair of requests in the request graph.

Embodiment 7 is the method of embodiment 5, further comprising:
in response to determining the pair of requests is non-conflicting, determining whether the pair of requests is mergeable by processing a second model input comprising the pair of requests using the third generative neural network with an instruction to determine whether the pair of the requests relate to a same portion of the first content item; and
in response to determining the pair of requests is mergeable, aggregating the pair of requests as a single node in the request graph.

Embodiment 8 is the method of any one of embodiments 5-7, wherein the third generative neural network is the first generative neural network.

Embodiment 9 is the method of any one of embodiments 1-8, wherein determining the set of non-conflicting requests using the data representing the request graph comprises:
identifying a clique comprising a largest set of non-conflicting requests using the edges connecting one or more pairs of nodes in the request graph.

Embodiment 10 is the method of any one of embodiments 1-9, wherein modifying the first content item comprises:
generating an initial modified content item by processing the first content item and the set of non-conflicting requests using the first generative neural network with an instruction to implement the set of non-conflicting requests;
identifying an unrestricted portion of the initial modified content item that is not part of a restricted portion of the initial modified content item that was modified by executing the set of non-conflicting requests; and
performing one or more updating iterations, wherein each updating iteration corresponds to executing a respective request from a remaining set of requests from the plurality of requests that (i) were not in the set of non-conflicting requests and (ii) pertain to the unrestricted portion, and wherein performing each updating iteration comprises:
   generating a next modified content item by processing the modified content item and the respective request corresponding to the updating iteration using the first generative neural network with an instruction to execute the respective request; and
   updating the unrestricted portion by removing a portion of the next modified content item that pertains to the respective request corresponding to the updating iteration.

Embodiment 11 is the method of embodiment 10, wherein performing each updating iteration further comprises:
in response to determining that the unrestricted portion is less than a threshold amount of the first content item, providing the next modified content item as the modified content item to the one or more users.

Embodiment 12 is the method of embodiment 11, further comprising:
providing the remaining set of requests that (i) were not in the set of non-conflicting requests and (ii) were not executed in any of the updating iterations to at least one of the one or more users.

Embodiment 13 is the method of any one of embodiments 1-12, further comprising:
for each of the plurality of requests, determining the respective portion of the first content item to which the request corresponds.

Embodiment 14 is the method of embodiment 13, wherein each request corresponds to an anchorpoint comprising a corresponding portion of the first content item specified for modification by the request, and wherein determining the respective portion of the first content item comprises obtaining the anchorpoint for each request.

Embodiment 15 is the method of embodiment 14, wherein obtaining the anchorpoint for each request comprises:
receiving the anchorpoint for the request; or
determining the anchorpoint for the request by processing the request and the first content item using the first generative neural network with an instruction to identify the corresponding anchorpoint for the request.

Embodiment 16 is the method of embodiment 15, wherein the first content item is a visual item, wherein the anchorpoints for each of the plurality of requests are segmentation masks, and wherein determining the anchorpoint for each request comprises:
extracting a plurality of segmentation masks using the visual item; and
identifying the segmentation mask corresponding with the request by processing the plurality of segmentation masks and the request using the first generative neural network with the instruction to identify the corresponding segmentation mask for the request.

Embodiment 17 is the method of embodiment 15, wherein the first content item is a textual item, wherein the anchorpoints for each of the plurality of requests are one or more text lines, and wherein determining the anchorpoint for each request comprises:
identifying the corresponding one or more text lines by processing the textual item and the request using the first generative neural network with the instruction to identify the corresponding one or more text lines for the request.

Embodiment 18 is the method of embodiment 15, wherein the first content item is an audio item, wherein the anchorpoints for the each of the plurality of requests are one or more audio tokens, and wherein determining the anchorpoint for each request comprises:
identifying an index for each of the one or more audio tokens corresponding with the request by processing the audio item and the request using the first generative neural network with the instruction to identify the corresponding one or more audio tokens for the request.

Embodiment 19 is the method of any one of embodiments 14-18, further comprising aggregating one or more anchorpoints based on a threshold criterion, wherein the threshold criterion comprises:
a similarity criterion for the one or more anchorpoints; or
a significance criterion for the one or more anchorpoints, wherein the significance criterion depends on a threshold number of requests referring to each anchorpoint.

Embodiment 20 is the method of any one of embodiments 1-19, wherein each request is assigned an importance weight, and wherein determining the set of non-conflicting requests using the data representing the request graph further comprises:
identifying one or more cliques of non-conflicting requests;
generating an importance score by aggregating importance weights for each clique of non-conflicting requests; and
determining the set of non-conflicting requests as the clique of non-conflicting requests with a highest importance score.

Embodiment 21 is the method of embodiment 20, wherein the importance score is determined based on an identifier of the one or more users that submitted each of the plurality of requests.

Embodiment 22 is the method of any one of embodiments 1-21, wherein the first generative neural network is a language processing model.

Embodiment 23 is the method of any one of embodiments 1-22, wherein the first generative neural network is a vision language model.

Embodiment 24 is a system comprising: one or more computers and one or more storage devices storing instructions that are operable, when executed by the one or more computers, to cause the one or more computers to perform the method of any one of embodiments 1 to 23.

Embodiment 25 is a computer storage medium encoded with a computer program, the program comprising instructions that are operable, when executed by data processing apparatus, to cause the data processing apparatus to perform the method of any one of embodiments 1 to 23.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a first content item;
receiving a plurality of requests from one or more users, each request specifying a respective modification to the content item to be made by a first generative neural network;
processing the plurality of requests to generate data representing a request graph, wherein the request graph comprises:
a set of nodes, each node representing a respective request corresponding to a respective portion of the first content item; and
a set of edges, each edge connecting a respective pair of nodes that represent a non-conflicting pair of requests;
determining a set of non-conflicting requests using the data representing the request graph; and
modifying the first content item to generate a modified content item, comprising executing the set of non-conflicting requests using the generative neural network.

2. The method of claim 1, further comprising:
providing the modified content item for presentation to the one or more users.

3. The method of claim 1, further comprising:
generating the first content item using the first generative neural network; or
obtaining the first content item as output from a second generative neural network.

4. The method of claim 1, wherein receiving the plurality of requests from one or more users comprises:
receiving an input stream of requests; and
buffering the input stream into batches, each comprising a respective set of requests, and wherein the plurality of requests are the respective set of requests in a first batch.

5. The method of claim 1, wherein processing the plurality of requests to generate data representing the request graph comprises, for each pair of requests in the plurality of requests:
determining whether the pair of requests is non-conflicting by processing a model input comprising the pair of requests using a third generative neural network with an instruction to determine whether the pair of requests can be implemented without conflict.

6. The method of claim 5, further comprising:
in response to determining the pair of requests is non-conflicting, generating an edge between the pair of requests in the request graph.

7. The method of claim 5, further comprising:
in response to determining the pair of requests is non-conflicting, determining whether the pair of requests is mergeable by processing a second model input comprising the pair of requests using the third generative neural network with an instruction to determine whether the pair of the requests relate to a same portion of the first content item; and
in response to determining the pair of requests is mergeable, aggregating the pair of requests as a single node in the request graph.

8. The method of claim 5, wherein the third generative neural network is the first generative neural network.

9. The method of claim 1, wherein determining the set of non-conflicting requests using the data representing the request graph comprises:
identifying a clique comprising a largest set of non-conflicting requests using the edges connecting one or more pairs of nodes in the request graph.

10. The method of claim 1, wherein modifying the first content item comprises:
generating an initial modified content item by processing the first content item and the set of non-conflicting requests using the first generative neural network with an instruction to implement the set of non-conflicting requests;
identifying an unrestricted portion of the initial modified content item that is not part of a restricted portion of the initial modified content item that was modified by executing the set of non-conflicting requests; and
performing one or more updating iterations, wherein each updating iteration corresponds to executing a respective request from a remaining set of requests from the plurality of requests that (i) were not in the set of non-conflicting requests and (ii) pertain to the unrestricted portion, and wherein performing each updating iteration comprises:
generating a next modified content item by processing the modified content item and the respective request corresponding to the updating iteration using the first generative neural network with an instruction to execute the respective request; and
updating the unrestricted portion by removing a portion of the next modified content item that pertains to the respective request corresponding to the updating iteration.

11. The method of claim 10, wherein performing each updating iteration further comprises:
in response to determining that the unrestricted portion is less than a threshold amount of the first content item, providing the next modified content item as the modified content item to the one or more users.

12. The method of claim 11, further comprising:
providing the remaining set of requests that (i) were not in the set of non-conflicting requests and (ii) were not executed in any of the updating iterations to at least one of the one or more users.

13. The method of claim 1, further comprising:
for each of the plurality of requests, determining the respective portion of the first content item to which the request corresponds.

14. The method of claim 13, wherein each request corresponds to an anchorpoint comprising a corresponding portion of the first content item specified for modification by the request, and wherein determining the respective portion of the first content item comprises obtaining the anchorpoint for each request.

15. The method of claim 14, wherein obtaining the anchorpoint for each request comprises:
receiving the anchorpoint for the request; or
determining the anchorpoint for the request by processing the request and the first content item using the first generative neural network with an instruction to identify the corresponding anchorpoint for the request.

16. The method of claim 15, wherein the first content item is a visual item, wherein the anchorpoints for each of the plurality of requests are segmentation masks, and wherein determining the anchorpoint for each request comprises:
extracting a plurality of segmentation masks using the visual item; and
identifying the segmentation mask corresponding with the request by processing the plurality of segmentation masks and the request using the first generative neural network with the instruction to identify the corresponding segmentation mask for the request.

17. The method of claim 15, wherein the first content item is a textual item, wherein the anchorpoints for each of the plurality of requests are one or more text lines, and wherein determining the anchorpoint for each request comprises:
identifying the corresponding one or more text lines by processing the textual item and the request using the first generative neural network with the instruction to identify the corresponding one or more text lines for the request.

18. The method of claim 15, wherein the first content item is an audio item, wherein the anchorpoints for the each of the plurality of requests are one or more audio tokens, and wherein determining the anchorpoint for each request comprises:
identifying an index for each of the one or more audio tokens corresponding with the request by processing the audio item and the request using the first generative neural network with the instruction to identify the corresponding one or more audio tokens for the request.

19. The method of claim 14, further comprising aggregating one or more anchorpoints based on a threshold criterion, wherein the threshold criterion comprises:
a similarity criterion for the one or more anchorpoints; or
a significance criterion for the one or more anchorpoints, wherein the significance criterion depends on a threshold number of requests referring to each anchorpoint.

20. The method of claim 1, wherein each request is assigned an importance weight, and wherein determining the set of non-conflicting requests using the data representing the request graph further comprises:
identifying one or more cliques of non-conflicting requests;
generating an importance score by aggregating importance weights for each clique of non-conflicting requests; and
determining the set of non-conflicting requests as the clique of non-conflicting requests with a highest importance score.

21. The method of claim 20, wherein the importance score is determined based on an identifier of the one or more users that submitted each of the plurality of requests.

22. The method of claim 1, wherein the first generative neural network is a language processing model.

23. The method of claim 1, wherein the first generative neural network is a vision language model.

24. A system comprising one or more computers and one or more storage devices storing instructions that are operable, when executed by the one or more computers, to cause the one or more computers to perform operations comprising:
obtaining a first content item;
receiving a plurality of requests from one or more users, each request specifying a respective modification to the content item to be made by a first generative neural network;
processing the plurality of requests to generate data representing a request graph, wherein the request graph comprises:
a set of nodes, each node representing a respective request corresponding to a respective portion of the first content item; and
a set of edges, each edge connecting a respective pair of nodes that represent a non-conflicting pair of requests;
determining a set of non-conflicting requests using the data representing the request graph; and
modifying the first content item to generate a modified content item, comprising executing the set of non-conflicting requests using the generative neural network.

25. A computer storage medium encoded with a computer program, the program comprising instructions that are operable, when executed by data processing apparatus, to cause the data processing apparatus to perform operations comprising:
obtaining a first content item;
receiving a plurality of requests from one or more users, each request specifying a respective modification to the content item to be made by a first generative neural network;
processing the plurality of requests to generate data representing a request graph, wherein the request graph comprises:
a set of nodes, each node representing a respective request corresponding to a respective portion of the first content item; and
a set of edges, each edge connecting a respective pair of nodes that represent a non-conflicting pair of requests;
determining a set of non-conflicting requests using the data representing the request graph; and
modifying the first content item to generate a modified content item, comprising executing the set of non-conflicting requests using the generative neural network.
